(19) United States
(12) Patent Application Publication
(10) Pub. No.: US 2025/0135379 A1
(43) Pub. Date: May 1, 2025

(54) A MICROPARTICLE FILTER, A TEXTILE TREATMENT APPARATUS, USE THEREOF AND A METHOD OF FILTERING MICROPARTICLES

(71) Applicant: XEROS LIMITED, Sheffield, South Yorkshire (GB)

(72) Inventor: James PEASE, Sheffield, South Yorkshire (GB)

(21) Appl. No.: 18/868,906

(22) PCT Filed: May 26, 2023
(86) PCT No.: PCT/GB2023/051395

§ 371 Date: Nov. 25, 2024

(30) Foreign Application Priority Data
May 31, 2022 (GB) 2208068.3
Oct. 7, 2022 (GB) 2214739.1

(51) Int. Cl. B01D 33/11; B01D 33/46; B01D 33/56; B01D 33/62; B01D 33/68; B01D 33/76; B01D 33/80

(52) U.S. Cl. CPC B01D 33/11; B01D 33/466; B01D 33/56; B01D 33/62; B01D 33/68; B01D 33/76; B01D 33/801; B01D 33/803

(57) ABSTRACT

A microparticle filter, textile treatment apparatus, use and method is disclosed. The microparticle filter comprises i) a filter chamber, the filter chamber comprising: an inlet for supplying effluent into the filter chamber and an outlet for filtered effluent to leave the filter chamber; a first set of chamber walls and a second set of chamber walls, wherein the first set of chamber walls and the second set of chamber walls in a first configuration are sealed together so that effluent cannot pass between the first set of chamber walls and the second set of chamber walls, and wherein the first set of chamber walls and the second set of chamber walls in a second configuration provide an opening; ii) a filter cage contained within the filter chamber, wherein the filter cage comprises one or more than one filter medium, the filter medium to filter microparticles from the effluent, and wherein the filter cage is rotatable around an axis, and wherein the filter cage defines an interior volume, and wherein the inlet is arranged to provide effluent to the interior volume of the filter cage and the outlet is arranged to receive filtered effluent from the filter cage; iii) a transfer member rotatable around the axis; iv) an actuator connected to the first set of chamber walls, and one of the filter cage or the transfer member and operable to move between the first configuration and the second configuration; v) a drive unit arranged to rotate the transfer member in at least the second configuration; wherein in the first configuration, the transfer member is located in the interior volume of the filter cage; and wherein in a second configuration, the transfer member is removed from the interior volume of the filter cage along the axis and the transfer member is rotatable to throw transferred filter residue off the transfer member through the opening, and wherein the transfer member comprises a filter residue collector to remove filter residue from the filter medium when the filter is changed from the first configuration from the second configuration.

### FIELD

The present disclosure relates to a microparticle filter, to a textile treatment apparatus comprising the microparticle filter. The present disclosure also relates to the use of the microparticle filter and the textile treatment apparatus, and to a method of filtering microparticles from an effluent containing microparticles.

### BACKGROUND

The washing of synthetic textiles is believed to be the largest contributor of microplastic pollution to the world's oceans, contributing an estimated 35% of primary microplastics. The release of microplastics from synthetic clothes is caused by the mechanical and chemical stresses that synthetic fabrics undergo during a washing cycle in a laundry machine. These stresses cause the detachment of microfibres from synthetic textiles. Due to their dimensions, the released microfibres often pass-through wastewater treatment plants and enter the oceans. Microfibres can be found in beaches worldwide, in the water of the Pacific Ocean, the North Sea, the Atlantic Ocean, the Artic, in deep sea sediments, and have recently been identified in human organs. Their size can cause them to be consumed by microorganisms, which are unable to digest them, causing them to persist and pass up the food chain. One difficulty with microparticle filtration is that as the efficiency of the filter is increased the more microparticles are captured. This increases the rate at which the filter can become blocked. This means that filter components such as the filter media need to be cleaned or replaced more frequently. Both cleaning and replacement increase the demands on the user and the latter also creates additional waste.

A number of filters have been developed to capture microparticles. Some filters attach externally between the outlet pipe of a washing machine and the wastewater drain. One example is manufactured by PlanetCare (www.planetcare.org) which has developed a filter that is used external to a washing machine, a device of this kind was published in PCT WO 2019/017848. The filter uses a static vertical cylindrical filter media held in a chamber. Wastewater passes through the filter media and out of the chamber. The filter becomes blocked, so periodically, the top of the chamber needs to be opened and the filter media extracted and replaced, placing demands on the users. Furthermore, most drains are located at the rear of the washing machine, and the washing machine outlet pipe usually exits from the rear of the washing machine. This means the PlanetCare filter and those similar to it may need to be located in a place that is inaccessible by the user, typically the rear of the washing machine, or a pipe can be used to bring the filter to the side of the washing machine. Often this can be impractical for users.

The above-described filter is designed for domestic washing machines which typically have small drums with a 7-12 Kg load capacity. Commercial washing machines i.e. those with a drum having a load capacity of 12 kg upwards, typically produce larger volumes of microparticle containing effluent which could rapidly block a domestic microparticle filter. The requirements of a commercial laundry are also different, the time taken by an employee to empty microparticle filters may increase the operating costs of the laundry. Thus, manual unblocking or replacing of filters is particularly undesirable in a commercial setting. Furthermore, commercial laundries typically use multiple machines, therefore it may be desirable to provide a filter with a high through put that can be connected to multiple washing machines to reduce capital expenditure. In commercial laundries space for filters may be limited as preference may typically be given to laundry apparatus that generates revenue. Therefore, a compact and affordable filter is desirable. Additionally or separately a filter which is more automated and/or requires less human intervention is desirable.

Another microparticle filter is described in WO 2019/122862 filed in the name of Xeros Limited. This filter is a centrifugal filter with a rotating filter cage, where the filter cage can be removed for emptying manually by the user. This filter can be made with a sufficiently large filtration through-put for use with a commercial laundry machine, but it still requires manual emptying.

WO2022084677 discloses multiple microparticle filters. However, in many of these embodiments, through-put is compromised or emptying of the filter residue is incomplete. Some of them also require complex apparatus arrangements.

The present inventors have sought to overcome one or more of the above identified problems of the prior art. The present inventors have also sought to address one or more than one of the following problems:
i. Providing reduced user demands;
ii. Providing high filtration efficiency;
iii. Providing high filtration through-put;
iv. Reducing filtration downtime;
v. Providing compact apparatus with reduced complexity.

### SUMMARY

In a first aspect, there is provided a microparticle filter suitable for filtering microparticles from effluent from a textile treatment apparatus, the microparticle filter comprising:
i) a filter chamber, the filter chamber comprising:
   an inlet for supplying effluent into the filter chamber and an outlet for filtered effluent to leave the filter chamber;
   a first set of chamber walls and a second set of chamber walls, wherein the first set of chamber walls and the second set of chamber walls in a first configuration are sealed together so that effluent cannot pass between the first set of chamber walls and the second set of chamber walls, wherein the first set of chamber walls and the second set of chamber walls in a second configuration provide an opening;
ii) a filter cage contained within the filter chamber, wherein the filter cage comprises one or more than one filter medium, the filter medium to filter microparticles from the effluent, and wherein the filter cage is rotatable around an axis, and wherein the filter cage defines an interior volume, and wherein the inlet is arranged to provide effluent to the interior volume of the filter cage and the outlet arranged to receive filtered effluent from the filter cage;
iii) a transfer member operable to rotate around the axis;
iv) an actuator connected to the first set of chamber walls, and one of the filter cage or the transfer member and operable to move between the first configuration and the second configuration;
v) a drive unit arranged to rotate the transfer member in at least the second configuration; and
   wherein in the first configuration, the transfer member is located in the interior volume of the filter cage; and
   wherein in a second configuration, the transfer member is removed from the interior volume of the filter cage along the axis and the transfer member is rotatable to throw transferred filter residue off the transfer member through the opening, and wherein the transfer member comprises a filter residue collector to remove filter residue from the filter medium when the filter is changed from the first configuration to the second configuration.

The present invention provides a filter with improved removal of microparticle containing residue from the filter medium. Thus, filtering through-flow and efficiency can be readily maintained. The present inventors have found that by first transferring the filter residue to a transfer member then rotating to throw through the opening, the speed, reliability and ease of removal of filter residue is improved. This means user intervention is not required and the speed of emptying is exceptionally quick. The emptying is also able to remove the majority of filter residue leaving little adhered to the filter chamber. The present invention also provides a compact and straightforward apparatus. The layout of the apparatus also provides for a high throughput. The apparatus can also be operated horizontally or vertically meaning it can be accommodated in a range of spaces.

### Axis

As used herein the term axis may refer to an imaginary line around which the transfer member and filter cage may rotate. The axis may be coaxial and parallel with the centre of rotation of the filter cage and the transfer member. The axis may also be coincident and parallel with an axis of rotational symmetry through the filter chamber, or the axis may pass through the centre of the filter chamber (i.e. coincident with the centre of mass where the chamber is assumed to be a homogenous body). Typically, the axis may be parallel with the horizontal direction when the microparticle filter is installed in the treatment apparatus. Alternatively, the axis may be parallel with the vertical direction. As used herein, the radial direction may refer to the direction perpendicular to the axis. A radial distance may be measured in the radial direction. Length as used herein may be measured parallel to the axis. Reference to the circumferential direction may refer to the direction rotating around the axis at a constant radius from the axis.

### Filter Chamber

The filter chamber comprises walls an inlet and an outlet. The walls of the filter chamber may be watertight and may define a volume that encloses the filter cage and the transfer member. The filter chamber may contain or direct the flow of the effluent from the inlet, through the filter media and out of the outlet, thus it may serve the function of containing effluent when in the first configuration. The filter chamber may be sealed in the first configuration, that is to say, the first set of chamber walls and the second set of chamber walls may be sealed water-tight so that no liquid can pass between. In this configuration, in normal use, liquid can only enter and exit via the inlet and outlet.

The walls of the filter cage may be arranged as a first set of chamber walls which are arranged to move with via actuator and a second set of chamber walls which may not be arranged to move by the actuator. Walls may be arranged to move by the actuator by comprising a connection thereto. The term “set of chamber walls” may comprise any number of chamber walls e.g. one, two, three or more chamber walls. In some embodiments, one set of chamber walls may comprise a single wall and the other set of chamber walls may comprise multiple walls.

Optionally, one of the first and second set of chamber walls may comprise a single end wall and the other of the first and second set of chamber walls may comprise an end wall and one or more sidewalls attached thereto. An end wall may be defined as a wall which passes through the axis. Optionally the end walls may be aligned perpendicular to the axis. A sidewall may be considered any wall which extends from one end wall towards the other end wall. Optionally a sidewall may extend parallel or substantially parallel to the axis. Optionally the first set of chamber walls may comprise a single end wall and the second set of chamber walls may comprise an end wall and one or more sidewalls. Alternatively, the second set of chamber walls may comprise a single end wall and the first set of chamber walls may comprise an end wall and one or more sidewalls. Optionally the first and/or second set of chamber walls may comprise end walls that are or approximate circles. Optionally the first and/or second set of chamber walls may comprise sidewalls that are cylindrical.

The chamber walls may be planar or may comprise a more complex or irregular shape e.g. hemispherical, cylindrical, or conical shapes amongst many others. The term wall is not limited to planar or curved walls of a constant radius. An individual wall may comprise varying shapes or forms e.g. walls with bends, holes, curves, ridges and other deviations. The term “wall” may refer to a watertight boundary to the filter chamber. Separate walls may be identified by a distinct angle or joint therebetween.

The walls of the filter cage may comprise one or more baffles. The baffles may be located on the first set of chamber walls or on the second set of chamber walls. The baffles may be shaped to locally disrupt fluid flow between the filter cage and the chamber walls proximal to the baffle. The one or more baffles may locally disrupt fluid flow by causing a localised reversal of flow back through the filter cage proximal to the one or more baffles. The one or more baffles may comprise protrusions extending radially inwards from the inner circumference of the first set of chamber walls or from the second set of chamber walls. The protrusion may be elongated and may extend in the axial direction. The extent in the axial direction may be equal to or may exceed the axial length of the filter cage or may extend for greater than 10% of the axial length of the filter cage, or greater than 25% of the filter cage or greater than 50% of the axial length of the filter cage, or greater than 75% of the filter cage. The closest portion of the baffle to the filter cage may be separated from the filter cage by a distance of no more than 0.5 mm, 1 mm, 2 mm, 5 mm, 10 mm, or 25 mm; and by a distance no less than 100 mm, 50 mm, 25 mm 10 mm, or 5 mm. The cross-section of the baffle when viewed from the axial direction may be a wave (including I.A. square wave, sine wave), a tooth (including I.A. saw tooth) or a bell shape amongst others. Multiple baffles may be arranged in series adjacent to one another or may be spaced around the inner circumference of the first set of chamber walls or the second set of chamber walls. The baffle may take any of the forms described in WO2022096880A1.

The filter chamber may take a range of shapes, including substantially cylindrical, elliptical and cuboidal, amongst others. A particularly preferred shape is one that is or approximates to a cylindrical shape. Prisms based on polygons with or without smoothed edges are also examples of suitable shapes, in particular, prisms based on higher order polygons i.e. those with 5 or more sides. Alternatively, shapes with a rotational symmetry of order 2 or greater about the axis may also be suitable.

The microparticle filter may comprise an outer annular seal for sealing the first set of chamber walls to the second set of chamber walls when the filter is in the first configuration. The outer annular seal may comprise one or more seal elements. The seal elements may comprise any known seal such as an O-ring seal or an X-Ring seal amongst others. The outer annular seal may comprise a compression seal. A compression seal may comprise a compressible material that compresses under an axial force. The compression seal may comprise a material with one or more hollow regions, non-limiting examples include foam or an elongated hollow rubber profile. The seal may be connected to the first set of chamber walls or to the second set of chamber walls. The seal may be mounted in a groove in the first set of chamber walls or the second set of chamber walls. The groove may extend up the radial faces of the seal as well as an axial face, to cover three sides thereof.

### Inlet and Outlet

The inlet and the outlet may be considered as openings into and out of the filter chamber through which microparticle containing effluent and filtered effluent passes during filtration. Optionally, the inlet and/or the outlet may comprise a plurality of openings in the chamber walls, collectively referred to herein in the singular as “inlet” or “outlet”. Where the inlet or outlet comprises more than one opening, the openings may be in the same wall or different walls, they may be in either or both of the first set of chamber walls and the second set of chamber walls. The inlet is typically the only pathway through which effluent may enter the filter chamber and the outlet is typically the only pathway through which filtered effluent liquid may exit the filter chamber during filtration.

The inlet may be comprised in one or more than one of the walls that comprise the filter chamber. The inlet may be comprised in the first set of chamber walls and/or the second set of chamber walls. Where the inlet is comprised in the first set of chamber walls it will move with the first set of chamber walls. The inlet may be located radially inwards of the outlet to the axis. The inlet may be coaxial with the axis.

The inlet is present irrespective of the configuration of the microparticle filter, however, it is primarily used when the filter is in the first configuration and the microparticle filter is supplied with effluent. The inlet may convey effluent into the interior volume of the filter cage. The inlet may convey effluent through either a base or a filter residue collector of the transfer member, optionally via a hole therein. Inlet may be connected to other conduits, channels or holes internally within the microparticle filter to convey effluent to where it is required within the filter chamber, e.g. to any of the aforementioned locations.

The inlet may be connected to a supply pipe, flexible hose, or other conduits external to the microparticle filter, these may optionally be connected to a textile treatment apparatus. The inlet may comprise a valve. The valve may control flow into the inlet and may be operable to stop flow. The valve may be operable by a controller as disclosed herein. The inlet may also comprise a sensor. The sensor may be a pressure sensor or a sensor to detect the presence of fluid. The sensor may return a sensing signal to a controller.

The outlet may be comprised in one or more than one of the walls that comprise the filter chamber. The outlet may be comprised in the first set of chamber walls and/or the second set of chamber walls. Where the outlet is comprised in the first set of chamber walls it may move with the first set of chamber walls via the actuator. The inlet and the outlet may both be in the first set of chamber walls or may both be in the second set of chamber walls of the filter chamber. Optionally inlet and the outlet may both be in the same individual chamber wall of the first set, or of the second set of chamber walls.

The outlet is present irrespective of the configuration of the microparticle filter, however, it is primarily used when the filter is in the first configuration and the microparticle filter is filtering effluent. The outlet may be located radially outward of the inlet from the axis. The outlet may be in an end-wall or a sidewall. The outlet may be annularly shaped and optionally may be radially outwards of the inlet from the axis.

The outlet may drain to an impellor chamber or may be connected to a conduit connected to drain effluent to sewerage (also referred to as a drain), into a water storage tank or to any other system for storing or disposing of effluent.

The outlet may comprise a plurality of openings, these may include a primary outflow pipe and a secondary outflow pipe. The primary outflow pipe may be at or close to the top of the filter chamber and the secondary outflow pipe may be at or close to the bottom of the filter chamber. The primary outflow pipe may allow air to escape from the filter chamber along with effluent during filtration and the secondary outflow pipe may allow residual filtered effluent to drain from the filter chamber. The primary outflow pipe may receive the majority of filtered effluent during operation. In this regard, the primary outflow pipe and the secondary outflow pipe may function in a similar manner to the embodiments described herein comprising a primary and secondary outflow pipe in an impellor chamber, or they may connect to the impellor chamber. Alternatively, the filter chamber may comprise a primary outflow pipe at or close to the bottom of the filter chamber and a secondary outflow pipe at or close to the top of the filter chamber. In this arrangement, the secondary outflow pipe may comprise an air release valve to bleed air from the filter chamber, and the primary outflow pipe may receive filtered effluent.

### Filter Cage

The filter cage is rotatable around the axis. Rotatable in this context may mean that the filter cage may be rotated relative to the filter chamber. The filter cage may be rotated by the drive unit indirectly via the transfer member or directly as explained below. The filter cage may be mounted to the first or second set of chamber walls via a rotary connection. The rotary connection may comprise a rotary bearing. A rotary bearing may comprise a bushing or plain bearing, a roller element bearing (e.g. a ball bearing, needle bearing amongst others), a magnetic bearing or a fluid bearing amongst others. The rotary connection may connect the filter cage to the first or second set of chamber walls. The rotary connection may be coaxially aligned with the axis. In particular embodiments, the first set of chamber walls and the filter cage are connected via a rotary bearing, permitting relative rotation therebetween.

The filter cage may be rotatable by the drive unit in the first configuration only, or in other embodiments, the filter cage may be rotatable by the drive unit in the first and second configurations.

The filter cage comprises a filter medium, optionally the filter cage may comprise a plurality of individual filter media. Where the filter cage comprises a plurality of filter media, collectively they are referred to herein in the singular as a filter medium.

The filter cage may comprise an open end and a closed end. The open end and the closed end may intercept the axis. The open end may comprise an opening sufficient for insertion and removal of the transfer member, in particular, for insertion and removal of the filter residue collector of the transfer member. The open end may comprise structures for engaging with and transferring drive to the transfer member, or for having drive transferred thereto from the transfer member. Non limiting examples of interlocking shapes include: splines, teeth, pins and holes and other known interlocking shapes. The open end may be sealed against the first or second set of chamber walls or the base of the transfer member when the microparticle filter is in the first configuration. The inner edge of the open end may be flush in the radial direction with the inner surface of the filter medium.

The closed end may comprise a hole, aperture, or conduit to convey effluent from the inlet to the interior volume of the filter chamber. The hole, aperture or conduit may be aligned with the inlet and may be positioned coaxially with the axis. The closed end may comprise a filter medium or may be non-porous. One or more sidewalls may extend from the open end to the closed end of the filter cage. The one or more sidewalls may comprise one or more filter media.

The filter cage may comprise a rigid structure. The filter cage may permit the filter medium to be rotated and in particular to be rotated without the filter medium becoming significantly distorted or bent by the centrifugal forces experienced during rotation. The filter cage may comprise a rigid structure unitary with the filter medium or they may be separable. The filter cage may comprise one or more filter cage fixings or filter cage location components to assist in fixing or locating the filter medium to the filter cage. The filter cage may be formed from two rigid layers with the filter medium retained in between or may be formed from a single layer with the filter medium attached thereto. The filter cage may comprise a lattice structure providing a series of windows between each lattice. Optionally, the filter medium may extend across each window. The windows may be square, rectangular, hexagonal, or octagonal among other shapes.

The filter cage may be substantially in the form of a cylinder, an ellipsoid, or a prism. A filter cage substantially in the form of the aforementioned shapes may comprise a form that approximates to those shapes including any shape in between. A prism may be a polygonal prism wherein the polygon has a number of sides of 4 or more, e.g. 4 to 20 sides. The polygonal prism may be a regular polygonal prism. Where the filter cage is a cylinder, the sidewall of the filter cage may comprise a single cylindrical wall. Where the filter cage comprises a polygonal prism, the number of filter cage sidewalls corresponds to the number of sides of the polygon, e.g. a hexagonal prism may comprise six rectangular side walls between two hexagonal end walls. The filter medium is preferably located in or on the one or more side walls of the filter cage. Optionally where the filter medium is a rigid material (e.g. a perforated metal sheet) the filter medium may be comprised as the filter cage sidewall. Preferably, the filter cage is cylindrical. Preferably the length along the axis of the filter cage (i.e. measured from the second end to the first end) is greater than the width measured perpendicular to the axis.

The filter cage may be rotationally symmetrical around the axis and may be balanced with respect to rotation. By balanced with respect to rotation it is preferably meant that the filter cage will not shake or vibrate unduly when rotated e.g. when rotated at 100 rpm or 1500 rpm or 3000 rpm.

When the filter chamber is a cylinder, or approximates or comprises a cylinder as hereinbefore described, the filter cage may rotate about the axis which may be aligned parallel to the side wall of the filter chamber and which may be substantially central within the filter chamber when viewed from directly along the axis, e.g. the filter chamber side walls and the filter cage are concentric when viewed from directly along the axis.

The filter cage may undergo rotation. The rotation may be during filtering, and/or dewatering, and/or throwing filter residue. The filter cage may be rotated at a G force at the perimeter of the filter media of at least 2G, or at least 5G, or at least 20G, or at least 40G, or at least 100G or at least 175G, or at least 250G or at least 325G or at least 450G. The G force optionally may not exceed 10,000G, or 2000G, or 1000G, or 500G at the radially outermost part of the filter cage. For a filter cage of radius r (cm), rotating at R (revolutions per minute (rpm)) and taking g as the acceleration due to gravity at 9.81 m/s², then:

G=1.118×10⁻⁵rR²

During filtering, dewatering, and/or throwing, the filter residue filter cage may have a number of revolutions per minute of at least 250, or at least 500, or at least 750, or at least 1000, or at least 1200, or at least 1400, or at least 1800. The number of revolutions per minute of the filter media optionally may not exceed 10,000, or 5000, or 2500, or 2000.

### Interior Volume

The filter cage defines an interior volume. The defined interior volume may be the interior volume bounded by the walls of the filter cage, including the one or more than one filter medium. Where the filter cage comprises openings, the interior volume 110 can be approximated by a hypothetical plane covering the opening to the filter cage as the bounds over the opening. For example, where the filter cage is a cylinder with an open end at one end and an inlet hole at the other, the interior volume is a cylinder that fits inside the filter cage bounded by a plane across the open end and a plane across the inlet hole. In the first configuration, the transfer member is located in the interior volume of the filter cage. In the second configuration the transfer member has been removed from the interior volume of the filter cage. During filtration, microparticle containing effluent may be provided to the interior volume of the filter cage from the inlet.

The region within the filter chamber and external to the filter cage may be defined as the region or volume exterior to the filter cage. In this region filtered effluent passes from the outer surface of the filter medium to the outlet.

### Filter Medium

The one or more than one filter medium may filter microparticles as effluent passes through it. Filtering in this context may comprise capturing microparticles against the filter medium as effluent passes through spacings, slits or pores therein it.

Thus the filter medium may comprise pores, including slits, gratings etc. The pores may be of a size suitable for filtering microparticles from the effluent.

The wording “a filter medium” used herein equally means “one or more on more than one filter medium or filter media”. The filter medium may comprise a porous material. The pores of the filter medium may have a mean pore size of no more than 100 μm, no more than 90 μm, no more than 80 μm, no more than 70 μm, no more than 60 μm, no more than 50 μm, no more than 40 μm, or no more than 30 μm. Such pore sizes have been found to provide excellent efficiency in the removal of microfibres whilst simultaneously not blocking too readily. In order of increasing preference, the pores in the one or more filter medium have a mean pore size of at least 1 μm, at least 2 μm, at least 5 μm, at least 10 μm, at least 20 μm, or at least 30 μm. Typically, the filter medium comprises pores with a mean pore size from 10 to 100 μm, from 20 to 70 μm, or from 30 to 60 μm.

The mean pore size may be the arithmetic mean pore size. The pore size may be considered the largest linear size of the pore. In the case of a circular pore, this would be a diameter. In the case of a pore taking the form of a slot, this would be the length of the slot.

The mean is preferably established by optical or electron microscopy using suitable image analysis software. The mean is preferably the mean of at least 100, more preferably at least 1,000 and especially at least 10,000 pores.

The number of filter media present in the microparticle filter is preferably no more than 100, more preferably no more than 50, especially no more than 20 and most especially no more than 10. Preferred numbers of filter media include 1, 2, 3, 4, 6 and 8.

The filter medium may comprise a mesh, a perforated sheet, woven or non-woven fibre sheet, cloth or felt, or porous material, or any other known filtration material. Where the filter media comprises a mesh, the mesh may comprise a network of wire or thread including a knitted mesh, a melt bonded mesh amongst others. The network of wire or thread may be non-woven or woven or may comprise a plurality of fibrous layers. The fibrous layers may optionally comprise two or more layers of fibres aligned in parallel with each layer typically in different orientations. The pores of the mesh may be formed from the different spacings between the wire or thread.

Where the filter medium comprises a perforated sheet, the pores may be the perforations. A perforated sheet may include a metallic or polymeric material where the material is, punched, punctured, cut, slit, or treated by any known method to introduce perforations into the material.

Where the filter medium comprises a porous material, the porous material may be a porous ceramic, a laminar surface with pores (e.g. a porous polymer membrane) or any other material that is inherently porous.

The one or more than one filter medium may be planar in shape, optionally one or more than one filter medium are curved in shape, optionally one or more than one filter medium are curved such that they adopt substantially the same shape as the side wall or side walls of the filter cage.

When one filter medium is present in the filter cage, the filter medium optionally is cylindrical in shape. When a plurality of filter media are present in the filter cage, the filter media optionally in combination act so as to form an approximately cylindrical shape when arranged in the filter cage.

The effluent moves through the filter medium in one direction and thus encounters one surface of the filter medium first. This surface is where filtered microparticles may accumulate during filtration and may be referred to as the filtration surface herein. Typically the filtration surface is the surface of the filter medium closest to the axis.

### Transfer Member

The transfer member is rotatable around the axis. Rotatable in this context may mean that the transfer member may be rotated relative to the filter chamber. The transfer member may be mounted to the first or second set of chamber walls via a rotary connection. The rotary connection may comprise a rotary bearing. A rotary bearing may comprise a bushing or plain bearing, a roller element bearing (e.g. a ball bearing, needle bearing amongst others), a magnetic bearing or a fluid bearing, amongst others. The rotary connection may connect the transfer member to the first or second set of chamber walls. The rotary connection may be coaxially aligned with the axis. The transfer member may be rotated by the drive unit indirectly via the filter cage or directly as explained below.

When the microparticle filter is in the first configuration the transfer member is located in the interior volume of the filter cage. Located in the interior volume of the filter cage may refer to at least a portion of the transfer member being located in the interior volume of the filter cage, or at least 25%, 50%, 75%, 90%, 95%, 99% or 100% of the length of the transfer member is located in the interior volume. The transfer member may comprise a filter residue collector, the transfer member may optionally be at the end of the transfer member closest to a closed end of the filter cage when the microparticle filter is in the first configuration.

The length of the transfer member may approximate the length of the sidewall of the filter cage, thus when the microparticle filter is in the first configuration one end of the transfer member (e.g. the filter residue collector end in some embodiments) may be adjacent to one end of the filter cage (e.g. the closed end of the filter cage in some embodiments). The other end of the transfer member (e.g. the base end in some embodiments) may be adjacent to one end of the filter cage (e.g. the closed end of the filter cage). Adjacent in this context may mean in contact with or spaced within 1, 2 or 5 cm in the axial direction.

When the microparticle filter is in the second configuration the transfer member is removed from the interior volume of the filter cage along the axis. In transiting from the first configuration to the second configuration, the transfer member is withdrawn from the interior volume of the filter cage; or the filter cage is withdrawn from around the transfer member, or both. This may comprise the filter cage moving along the axis relative to the filter chamber and/or the transfer member moving along the axis relative to the filter chamber. Removed from the interior volume in this context may refer to the portion of the transfer member in the interior volume being reduced between the first and second configurations. The portion of the length of the transfer member in the axial direction that is in the interior volume from the first to the second configuration may be reduced by at least 10%, 20%, 30%, 40%, 50%, 60%, 70%, 80%, 90%, 95%, 99% or by 100%. In some embodiments the transfer member may be removed from the interior volume of the filter cage such that only the filter residue collector or a portion thereof remains in the interior volume. That is to say, in the second configuration the filter residue collector may overlap with the filter cage such that a portion of the filter cage is radially outwards of the filter residue collector from the axis only, whereas the remainder of the transfer member has been removed. Alternatively the transfer member may be completely separated from the filter cage such that there is no overlap in the radial direction from the axis between the transfer member and the filter cage. In some embodiments, transiting from the first configuration to the second configuration may comprise moving the transfer member with an oscillating movement. This may increase the detachment of residue from the filter medium.

The transfer member comprises a filter residue collector to remove filter residue from the filter medium when the filter is changed from the first configuration to the second configuration. This change is performed by operating the actuator to move the first apparatus connected to it. Removal of filter residue may comprise lifting, scraping, pushing or otherwise transferring filter residue off the filter medium by the filter residue collector. The filter residue collector may transfer filter residue from the filter medium to the transfer member during removal from the interior volume of the filter cage. The filter residue collector may be a portion of the transfer member that is adapted to remove filter residue that has accumulated on the filter medium and collect the filter residue on the surfaces of the transfer member. Exemplary adaptations are described as follows. The filter residue collector may be in contact with the filter medium when in the first configuration. In some embodiments, the largest linear gap between the filter residue collector and the filtering surface of the filter medium is in order of preference no more than 2 mm, 1 mm, 0.5 mm, 0.25 mm, 0.1 mm or 0.05 mm when measured in the radial direction.

The filter residue collector may comprise a cross-sectional shape geometrically similar to the cross-section of the interior volume. The cross-sectional shape may be taken perpendicular to the axis. The cross section of the interior volume is essentially the two-dimensional shape bounded by the filter cage at a particular point along the axis. Thus, where the filter cage is a hexagonal prism, the interior volume will be a hexagonal prism, and optionally so too will the filter residue collector, for example. Geometrically similar may refer to the cross-sectional shape of the filter residue collector being the same size or proportionally smaller than the cross section of the interior volume. The filter residue collector may be a disk, annulus, cup shape, hemisphere or any shape that has a circumference, a radially outer perimeter or an edge that contacts the filter medium. The filter residue collector may have a cut-out portion to accommodate residue not removed from the filter cage. Alternatively, the filter residue collector may stop short of the end of the filter cage when in the first configuration to accommodate unremoved residue.

Removal of the transfer member from the interior volume may cause the filter residue collector to be pulled across the filter medium. This may scrape or push the residue off the filter medium and onto the transfer member, and out of the interior volume of the filter cage. Transferred residue may adhere to the surfaces of the transfer member, this may optionally be and/or include surfaces of the filter residue collector. Microparticle containing filter residue may be sufficiently damp that it readily adheres to the surfaces of the transfer member. The scraping or pushing may be done by the radially outer perimeter of the filter residue collector. The filter residue collector may comprise a conformable member for contacting the filter medium. The conformable member may be at the radially outer perimeter of the filter residue collector. The conformable member may be a flexible element. A flexible element may be any element that conforms to the surface of the filter medium improving contact therewith. The flexible element may comprise rubber or a polymer amongst others. This may be in the shape of a wedge, blade, captured O-ring, or cap on the filter residue collector that conforms to the surface of the filter medium. Alternatively the flexible element may comprise a brush formed of individual bristles. Where rotation of the transfer member causes rotation of the filter cage, an interference fit between the filter between the transfer member and the filter cage may be used to transfer the rotational drive. A flexible element may improve the interference fit for transferring drive. Alternatively, the filter cage and/or the transfer member may comprise structures (e.g. teeth, pins, splines etc) that interlock with corresponding structures on the other of the filter cage and/or the transfer member in the first configuration.

The filter residue collector may comprise a plurality of conformable members. The conformable members may be spaced along the axial direction. In some embodiments, the conformable elements may extend in the axial direction, in a non-limiting example, they may be helical.

The filter residue collector may be at the end of the transfer member that goes furthest into the filter cage in the first configuration. I.e. the end which moves the furthest distance along the filter medium when the transfer member is removed from the interior volume of the filter cage. Where the filter cage comprises an open end and a closed end, this may be the end of the transfer member closest to the closed end of the filter cage.

The transfer member is rotatable to throw transferred filter residue off the transfer member through the opening. Rotatable in this context may mean that the transfer member can be rotated at a sufficient angular velocity to throw filter residue off the transfer member. The transferred filter residue is the residue that is on the surface of the transfer member after transitioning from the first configuration to the second configuration. The transferred filter residue is thrown when the centrifugal force exceeds the adhesion of the transferred filter residue to the surfaces of the transfer member. The minimum RPM needed to throw transferred filtered residue can be determined experimentally by operating the microparticle filter and adjusting the RPM accordingly. The rotation of the transfer member by the drive unit may cause rotation of the filter cage via rotation of the transfer member when the filter is in the first configuration only. Thus, the rotation of the transfer member in the second configuration may not rotate the filter cage. Alternatively, rotation of the filter cage may drive rotation of the transfer member in the first and optionally in the second configurations.

The transfer member may have a diameter of at least 50 mm, or at least 75 mm, or at least 100 mm, or at least 150 mm, or at least 200 mm. The transfer member may have a diameter not exceeding 500 mm, or 400 mm, or 300 mm, or 200 mm, or 150 mm. The diameter may be measured perpendicular to the axis.

The transfer member may comprise a base at the opposing end of the transfer member to the filter residue collector. This may be the end closest to an open end of the filter cage when in the first configuration. The base may be a disk shape or other planar shape. The base may be shaped to close an open end of the filter cage. Thus the base may comprise a corresponding shape to the open end of the filter cage. The base may comprise a hole or aperture that is aligned with the inlet to permit the entry of effluent. The microparticle filter may comprise an inner annular seal for sealing the filter cage to the transfer member when the filter is in the first configuration. The inner annual seal may be retained to the filter cage or to the transfer member. Optionally the inner annual seal may be retained to the base to contact the filter cage in the first configuration. In particular, the inner annual seal may be retained proximal to the radially outermost part of the base of the transfer member. The inner annular seal may comprise a compression seal. The compression seal may comprise a compressible material that compresses under an axial force. The compression seal may comprise a material with one or more hollow regions, non-limiting examples include foam or an elongated hollow rubber profile. The inner annular seal may be mounted in a groove in the filter cage or the transfer member, and in particular in the base. The groove may extend up the radial faces of the seal as well as an axial face.

The transfer member may comprise one or more than one flow induction blade. The flow induction blades may comprise members which rotate with the transfer member to induce circumferential flow in the interior volume of the filter cage when the microparticle filter is in the first configuration. The flow induction members may comprise elongate faces which face circumferentially into the effluent when the transfer member is rotated. The flow induction blades may extend approximately parallel to the axis. The flow induction blades may be positioned radially outwards of the axis. The flow induction blades may extend from the base to the filter residue collector. The transfer member may comprise one or more than one flow induction blades, for example 2, 3, 4, 5, 6 or more flow induction blades. The flow induction blades may be equally spaced around the perimeter of the transfer member.

### Actuator

The microparticle filter comprises an actuator connected to the first set of chamber walls and the filter cage, or to the first set of chamber walls and to the transfer member. Connected to, in this context, means connected either directly or indirectly so that operation of the actuator causes the connected integers to move with the actuator. For example, the actuator may comprise a shaft, rod or other elongate structure that connects the actuator to the first set of chamber walls. In this example, the filter cage or transfer member may also be connected to the shaft, or to the first set of chamber walls. Any of the aforesaid integers may be connected via a boss, bearing or other connecting structure to the rod or actuator. In some embodiments, the actuator is connected to the first set of chamber walls and to the filter cage. Optionally, the filter cage may be connected to the first set of chamber walls by a rotary bearing. Optionally the actuator may move the filter cage and the first set of chamber walls together between configurations when actuated. The actuator may move linearly, and/or may be arranged to induce linear motion in the apparatus connected to the actuator. The actuator may be arranged to move the apparatus connected to the actuator parallel to the axis.

The actuator is operable to move the transfer member between the first configuration and the second configuration. The actuator may be operable by pulling or pushing the connected integers between the first and second configurations. The actuator may be operable upon receipt of a control signal. Where applicable, this may be from a controller. An actuator may comprise amongst others: hydraulic devices, pneumatic devices, and electromechanical devices. Non-limiting examples of electromechanical devices include electric linear motion actuators, rotary motors, and electromagnets.

### Drive Unit

The drive unit is arranged to rotate the transfer member in the second configuration. The drive means may also be arranged to rotate the transfer member in the first configuration. Arranged in this context may refer to the drive unit being positioned and connected either directly or indirectly to the transfer member such that rotation of the drive unit causes rotation of the transfer member. The drive unit may be connected directly to the transfer member, i.e. a rotating element of the drive means extends to the transfer member. The rotating element may include a rotor or drive shaft or any other component whose primary function is to transfer rotary drive. Alternatively, the drive means may be connected indirectly to the transfer member, e.g. via other elements that are capable of transferring rotary drive as a secondary function, for example, via a filter cage comprising an interference fit or a splined connection to the transfer member. Optionally the drive means may be connected to the transfer member via the filter cage. The filter cage may comprise a structure to transfer drive to the transfer member, these may comprise coopering surfaces such as teeth or splines, a conformable element, or a friction surface for example. Similarly, the transfer member may comprise corresponding structures. The structures may engage in the first and/or second configurations. The drive means may comprise sufficient torque to rotate the transfer member at a speed suitable to throw transferred filter residue off the transfer member through the opening. In some embodiments, the drive means may rotate the filter cage and transfer member in the first configuration and rotate the transfer member in the second configuration only. In some embodiments, the drive means may rotate the filter cage only in the first configuration and the transfer member only in the second configuration. In some embodiments, the drive means may rotate the filter cage and transfer member in both configurations.

The drive unit may comprise a motor, optionally an electric motor. The electric motor may comprise a rotor. The rotor of the motor may be concentric with the axis and drive shaft. Alternatively, the motor may be located remote from the axis, e.g. the rotor of the motor may rotate about an axis parallel to but not coincident with the axis of the filter chamber. In such embodiments, the rotor may be connected to rotate the transfer member via a pulley or a geared connection. The motor may have a power consumption of at least 0.6 kW, or at least 0.9 kW, or at least 1.2 kW, or at least 1.5 kW. The motor may have a power consumption not exceeding 5 kW, 4 Kw, 3 kW or 2 kW. In the first configuration the drive unit may rotate the transfer member and the

filter cage. In the second configuration the drive unit may rotate the transfer member only or the transfer member and the filter cage. Rotation in the first configuration may additionally assist in urging the liquid through the microparticle filter and/or assisting in dewatering the filter residue. Rotation in the second configuration may be to remove residue from the transfer member. The drive unit may be operable to rotate at different speeds for filtration dewatering and residue removal. Alternatively dewatering and residue removal may be performed at the same speed. The drive means may operate upon receipt of a control signal. This may be in the form of a source of electrical energy. The control signal may be provided by a controller where applicable.

### The Opening

The opening may be a gap or space in the chamber wall when the microparticle filter is in the second configuration. The opening may be between the first set of chamber walls and the second set of chamber walls. The opening may extend around the axis. The extent may comprise an arc up to 90°, up to 180°, up to 270° or up to 360°.

### Impellor

The microparticle filter may comprise an impellor chamber. The impellor chamber may be connected to and adjacent to the outlet of the filter chamber. Thus the impellor chamber is able to receive filtered effluent from the outlet of the filter chamber. The impellor chamber may comprise an impellor in the impellor chamber. The impellor may be rotatable around the axis by a drive unit to expel filtered effluent from the impellor chamber. The impellor may also suck effluent through the filter chamber improving filtration throughput. The impellor chamber may be shaped as a volute around the impellor. The impellor chamber may comprise an outflow pipe for draining effluent from the impellor chamber. The (primary) outflow pipe may be positioned at or close to the top of the impellor chamber. The outflow pipe may be arranged tangentially from the impellor chamber. The outflow pipe may discharge filtered effluent during the operation of the impellor. The impellor chamber may comprise a secondary outflow pipe at or close to the bottom of the impellor chamber for draining effluent from the impellor chamber. A secondary outflow pipe at or close to the bottom of the impellor chamber may passively drain the remaining filtered effluent in the impellor chamber under the influence of gravity when the impellor is not operating. The bottom of the impellor chamber may be below the bottom of the filter chamber so that filtered effluent in the filter chamber can drain passively under the influence of gravity into the impellor chamber. The top of the impellor chamber may be higher than the top of the filter chamber so that air bubbles may move into the impellor chamber.

The microparticle filter may comprise a supply pipe to provide effluent to the inlet, the supply pipe may pass through the impellor chamber. The supply pipe may be aligned parallel with the axis. The impellor may be fixed to the supply pipe and the supply pipe may be rotatable by the drive means. Additionally the transfer member and/or filter cage may be connected to the supply pipe to be rotated by it. Thus the supply pipe may function as a drive shaft.

### Controller

The microparticle filter may further comprise a controller. The controller may comprise a processor and control logic. The controller may be able to access control logic to operate the drive unit and the actuator. The controller may operate the actuator and drive unit to place the filter cage in the first configuration and second configuration and to rotate the transfer member in the second configuration. Alternatively, a textile treatment apparatus may comprise a controller operable to control the microparticle filter. A controller in the microparticle filter may receive input relating to the status of the textile treatment apparatus. A controller may also receive input from sensors in the microparticle filter, the textile treatment apparatus, and/or the connection between the microparticle filter and textile treatment apparatus. The controller of the microparticle filter may have memory loaded with a programme, or access to a programme, which when operated by a processor, controls the actuator and drive means of the microparticle filter. The programme may receive inputs and determine appropriate outputs to the actuator and drive means. Where the controller is in the microparticle filter, the microparticle filter may not be under the direct control of the textile treatment apparatus but instead may “have a knowledge” of what the textile treatment apparatus is doing and can respond accordingly. As an example, the controller in the microparticle filter may sense that the waste valve in the textile treatment apparatus has been opened and/or that a waste pump has been activated and it may then respond by powering the actuator of the microparticle filter to place in the first configuration and operate the drive means so as to begin filtration. The memory of the microparticle filter may be comprised as part of the microparticle filter or may be accessible via wireless, internet or other communication means. The microparticle filter and/or textile treatment apparatus may comprise sensors (for example, pressure or fluid sensors in the drain outlet of the treatment apparatus or in the filter chamber and/or sensors to determine the volume of effluent passed to the filter). The controller may be configured to operate the microparticle filter based on input from such sensors. Alternatively, or in addition, the controller may be configured to operate the microparticle filter after a condition pertaining to a wash cycle is identified (e.g. completion of a wash cycle or detection of effluent).

The controller may be configured to operate the actuator and drive unit to place the microparticle filter in the second configuration to remove filter residue from the filter chamber to a collection chamber via the opening in the filter chamber. Operation of the microparticle filter by the controller may comprise operating the actuator and drive means of the microparticle filter to remove the residue from the filter chamber without requiring manual emptying by a user.

### Collection Chamber

The microparticle filter may comprise a collection chamber. The collection container may be a container radially outward of the opening. The collection chamber may receive filter residue thrown from the transfer member. The collection chamber may circumferentially surround the opening for an extent comparable to the opening.

For example, where the opening extends around the axis for 360 degrees, the collection chamber may also extend around the axis for 360 degrees. The collection chamber may comprise multiple parts which can be withdrawn from the microparticle filter for emptying, optionally these may be withdrawn as drawers.

### Effluent

As used herein, an “effluent” is the substance to be filtered by the microparticle filter. The effluent is the feed that is supplied to the inlet of the microparticle filter. Typically, the effluent is a liquid comprising a particulate solid material. Some or all of the solid material is removed from the effluent by the filter medium. The resulting substance is filtered effluent. Typically, the effluent may comprise a textile treatment formulation that has been used in the treatment of textiles such as garments. The amount of solid material in the effluent may vary depending on the textile being treated, the type of treatment and the stage of the treatment. As such the concentration of solids in the effluent may vary considerably.

The solid material in the effluent typically includes particles derived from the textiles (may also be known as “lint”), soil or a combination thereof. The solid material present in the effluent may be in the form of particles, especially microparticles. Preferably, the particles are or comprise fibres, in particular microfibres. The effluent preferably comprises at least some fibres as the solid material. The fibres in the effluent may be natural, synthetic, semi-synthetic or a mixture thereof. Natural fibres may include cellulose microfibres.

For particles which are or comprise fibres, the fibres preferably have a longest linear dimension of greater than about 1 μm and typically no longer than about 5 mm, or preferably no longer than about 1 mm. Fibres having a longest linear dimension of greater than about 1 μm and typically no longer than about 0.5 mm, typically less than about 1 mm, may be referred to as “microfibres” herein.

The effluent may comprise less than 30 wt. %, or less than 20 wt. % and or less than 10 wt. % of solid material prior to entry into the filter (as a percentage of the total mass of the solid material and the liquid). The effluent may comprise at least 0.001 wt. %, or at least 0.01 wt. %, or at least 0.1 wt % of solid material (as a percentage of the total mass of the solid material and the liquid).

The effluent may comprise from about 0.01 wt. % to about 5 wt. % solid material, or from about 0.1 wt. % to about 3.5 wt. % solid material (as a percentage of the total mass of the solid material and the liquid).

The effluent is preferably flowable i.e. a liquid and not in the form of a paste or semi-solid. The effluent is typically an aqueous liquid. When the effluent comprises liquids other than water these may be alcohols, ketones, ethers, cyclic amides and the like. The liquid may comprise at least 50 wt %, or at least 80 wt %, or at least 90 wt % of water.

The textiles may be cellulose containing textiles. In particular the textiles may comprise garments.

The effluent may be received by the microparticle from one or more than one textile treatment apparatus.

### Textile Treatment Apparatus

In a second aspect there is provided a textile treatment apparatus comprising a microparticle filter according to the first aspect.

The textile treatment apparatus may be a textile washing apparatus. The textile treatment apparatus may be adapted for washing textiles with a treatment formulation comprising a liquid, the textile treatment apparatus comprising a drum for rotating the textiles and the treatment formulation, a drive means for rotating the drum and a microparticle filter according to the first aspect. Preferably, the textile treatment apparatus is a washing machine.

A textile treatment machine may include machines adapted for colouring (e.g. dyeing), stonewashing, abrading, and applying surface treatments to garments or textiles used in the production of garments. A textile treatment machine may have a capacity permitting no more than 15 Kg, or 25 Kg, or 50 Kg, or 100 Kg, or 500 Kg of dry textiles to be treated at any given time. The drum volume of a textile treatment machine may be up to 100 L, 500 L, 1000 L or 5000 L.

The textile treatment machine may be a washing machine and may include a domestic washing machine or a commercial washing machine. A domestic washing machine may have a capacity permitting no more than 15 Kg of dry textiles to be washed at any given time. Typically, a domestic washing machine is either a front loading machine or a top loading washing machine. Often domestic washing machines are about 60 cm wide, 60 cm deep and about 85 cm tall. The drum of a domestic washing machine preferably has a capacity of at least 1 litre and more preferably at least 10 litres and preferably no more than 150 litres, or no more than 120 litres.

A commercial washing machine may have a capacity greater than 15 Kg of dry textiles to be washed at any given time. The drum of the textile treatment apparatus may have a capacity of more than 120 litres, more than 150 litres more than 200 litres, more than 400 litres, more than 900 litres or more than 1400 litres. Drums of such larger dimensions are especially suitable for commercial or industrial applications. The drum may have any upper limit to its capacity, preferably the drum has a capacity of no more than 20,000 litres or no more than 10,000 litres. The textile treatment apparatus may comprise a drum, the drum having a capacity from 200 L to 20,000 L.

### Use

In a third aspect there is provided a use of the microparticle filter or textile treatment apparatus according to the first or second aspects for filtering microparticles from an effluent stream comprising effluent from treated textiles.

The effluent may be from the treatment of textiles that may comprise synthetic fabrics, cotton and/or polycotton. The treated textiles may be textiles that are being treated by washing. The use of the microparticle filter or textile treatment apparatus may be for the filtering of cellulose microparticles and or synthetic microparticles.

The use of the textile treatment apparatus according to the third aspect may comprise the treatment of textiles comprising synthetic fabrics or cellulose containing fabrics. In particular, the textile may comprise the treatment of cotton or polycotton. The textile treatment apparatus may be as described under the second aspect. The textile treatment apparatus may comprise a drum, the drum having a volume between 120 L or 150 L and 20,000 L or between 200 L and 10,000 L or between 500 L and 5000 L or between a range formed from any of these end points.

The use may be performed according to the method of the fourth aspects.

### Method

In a fourth aspect, there is a method of filtering microparticles from effluent from

a textile treatment apparatus comprising:
i. providing a microparticle filter according to the first aspect;
ii. operating the actuator to place the microparticle filter in the first configuration;
iii. supplying effluent from a textile treatment apparatus to the inlet of the microparticle filter;
iv. filtering the effluent through the filter medium and passing the filtered effluent to the outlet;
V. stopping the supply of effluent;
vi. operating the actuator to place the microparticle filter in the second configuration;
vii. operating the drive unit to rotate the transfer member to throw filter residue from the transfer member out of the opening.

The method may be a method of filtering microparticles from effluent from a textile treatment which has treated synthetic and or cellulose containing textiles.

The method may further comprise the subsequent steps of: repeating steps ii. to vii. one or more than one times.

After supply of the effluent has been stopped, any remaining filtered effluent in the filter chamber may be allowed to drain via the outlet before step vi.

The supply of effluent may be from a single treatment cycle of the textile treatment apparatus. The filter residue may be dewatered by rotating the filter cage between steps v and vi. Dewatering may comprise rotating the filter medium to centrifugally remove water from the residue.

The supply of effluent may be from a single treatment cycle of the textile treatment apparatus. The effluent from a single treatment cycle may be delivered in one continuous stream, or the supply of effluent from a single treatment cycle may be supplied intermittently. The supply of effluent may come from a plurality of textile treatment apparatuses. That is, more than one textile treatment apparatus may be connected to a single microparticle filter.

Aspects of the present invention are especially suited to filtering particles which are or comprise fibres and at least some of the said fibres have a longest linear dimension of from 1 μm to 500 μm. The present inventors have found the filter, textile treatment apparatus, use and method are especially suited to filtering and at least partially removing fibres of this size.

The fibres being filtered in the method of the fourth aspect of the present invention typically originate from a textile which has been treated in a liquid medium.

The treatments preferably include washing, colouring (especially dyeing and pigmenting), abrading, ageing, softening, rinsing, bleaching, sterilising, desizing and depilling and combinations thereof.

The method is especially suited to filtering effluent which originates from a treatment or from treatment apparatus as previously mentioned.

Preferably, the textile treatment apparatus is used to rotate (especially tumble) one or more textiles and a liquid medium in a drum.

At least some of the fibres in the effluent may comprise synthetic fibres. Examples of synthetic fibres include: nylon, polyester, polyurethane, acrylic, acrylonitrile and the like.

The effluent may be at a temperature of from 5 to 95° C., more preferably from 5 to 70° C. and especially from 10 to 60° C. as it passes through the filter.

Typically, the microparticle filter is primed with liquid, more preferably with an aqueous liquid and especially with water prior to the effluent entering the filter, or primed with the effluent.

In order of increasing preference, the microparticle filter according to the first aspect of the present invention or the textile treatment apparatus according to the second aspect of the present invention is able to filter effluent from at least 2, 3, 4, 5, 10, 20, 30, 50 and 100 treatment cycles prior to becoming blocked or requiring cleaning.

In order of increasing preference, the microparticle filter according to the first aspect of the present invention or the textile treatment apparatus according to the second aspect of the present invention is able to filter effluent whose total volume is at least 10, 50, 100, 500, 1000, 5000 and 10,000 litres prior to becoming blocked or requiring cleaning.

The microparticle filter may be operated such that the effluent flows through the filter once (and only once). The filter may be operated such that the effluent of one treatment cycle is cycled through the filter several times. Cycling through the filter can provide especially good efficiencies of filtration although the filtering times required may be a little longer. Preferably, the effluent is cycled through the filter at least 2, 3, 4 and 5 times. Preferably, the effluent feed is cycled through the filter no more than 100 times. The number of cycles of an effluent feed may be considered to be the total volume of liquid passed through the filter in a treatment cycle divided by the volume of fresh liquid used in the treatment cycle.

It will be appreciated that the features, preferences, and embodiments described hereinabove may be applicable where combinations allow, to each of the figures. The aspects of the present disclosure are further described with reference to the following figures.

### SUMMARY OF THE FIGURES

FIG. 1a shows a side view of a microparticle filter in the first configuration according to the first aspect of the present disclosure.

FIG. 1b shows an isometric view of the microparticle filter of FIG. 1a in the first configuration.

FIG. 1c shows a side view of the microparticle filter of FIG. 1a in the second configuration.

FIG. 1d shows an isometric view of the microparticle filter of FIG. 1a in the second configuration.

FIG. 1e shows a cross-sectional side view along the axis of the microparticle filter of FIG. 1a in the first configuration.

FIG. 1f shows a side view of the microparticle filter of FIG. 1a in the second configuration with a drive means.

FIG. 2a is a drawing of an alternative microparticle filter in the first configuration according to the first aspect of the present disclosure.

FIG. 2b is a drawing of the microparticle filter of FIG. 2a in the second configuration.

FIG. 3 is a drawing of an alternative microparticle filter according to the first aspect of the present disclosure.

FIG. 4 is a drawing of an alternative microparticle filter according to the first aspect of the present disclosure.

FIG. 5 is a schematic drawing of a textile treatment apparatus according to the second aspect of the present disclosure.

FIG. 6 is a flow diagram of a method according to the fourth aspect of the present invention.

### DETAILED DESCRIPTION

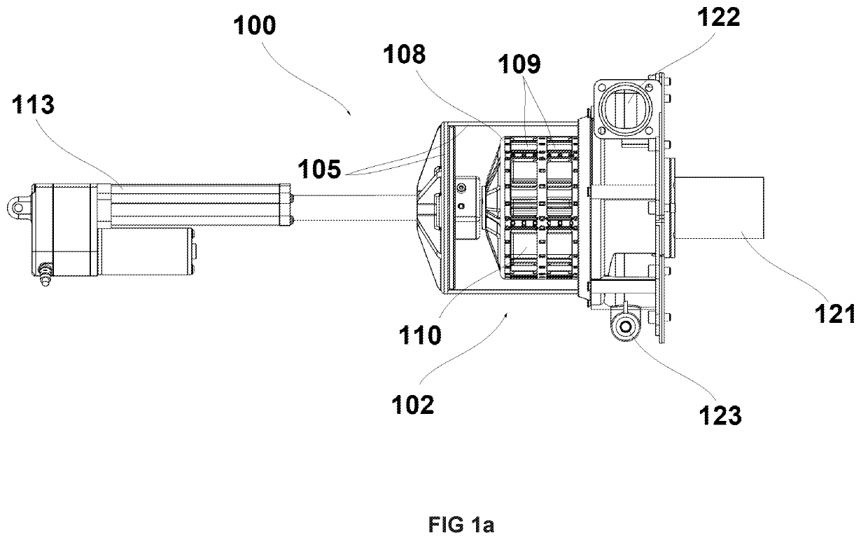

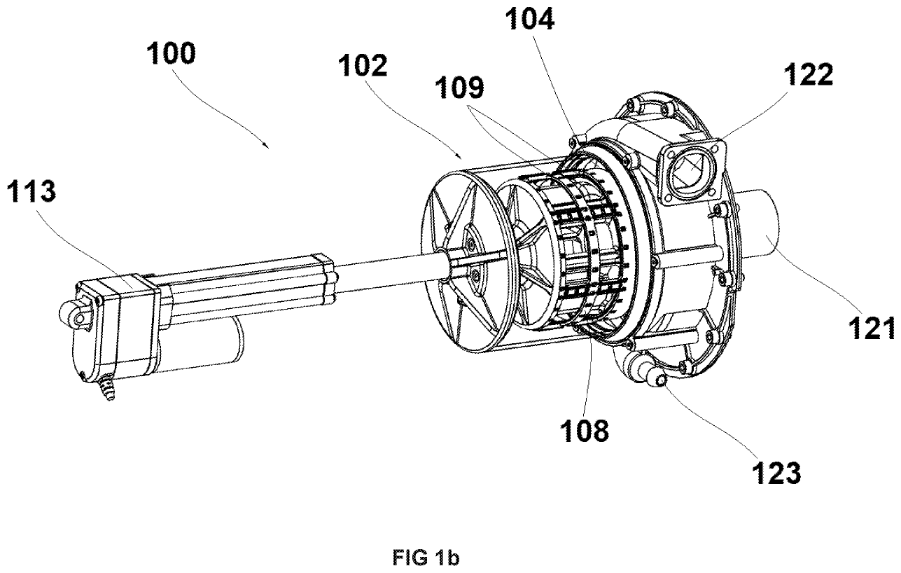

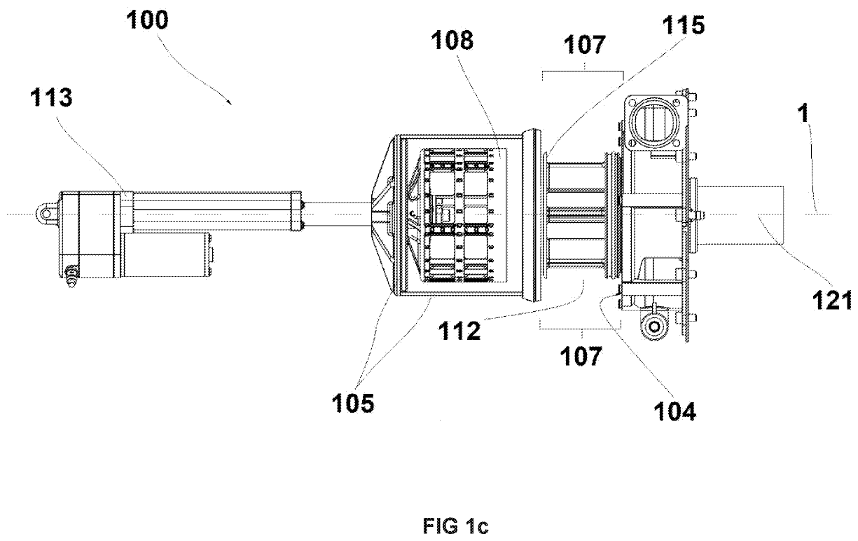

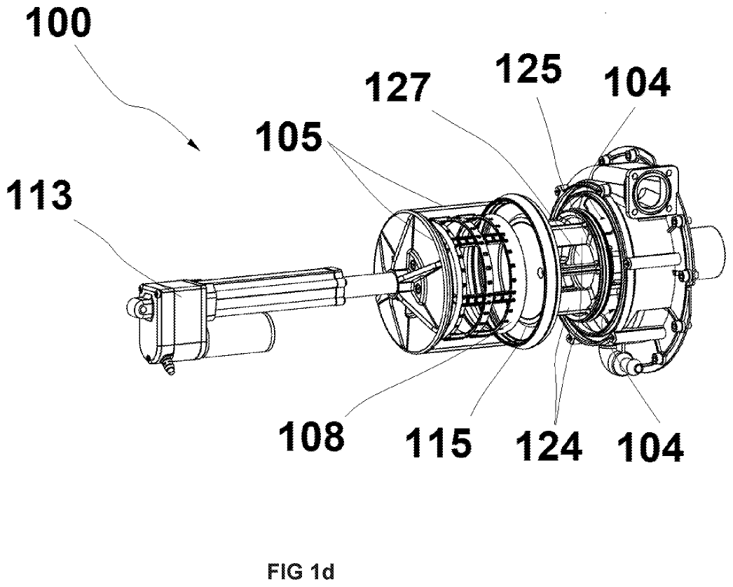

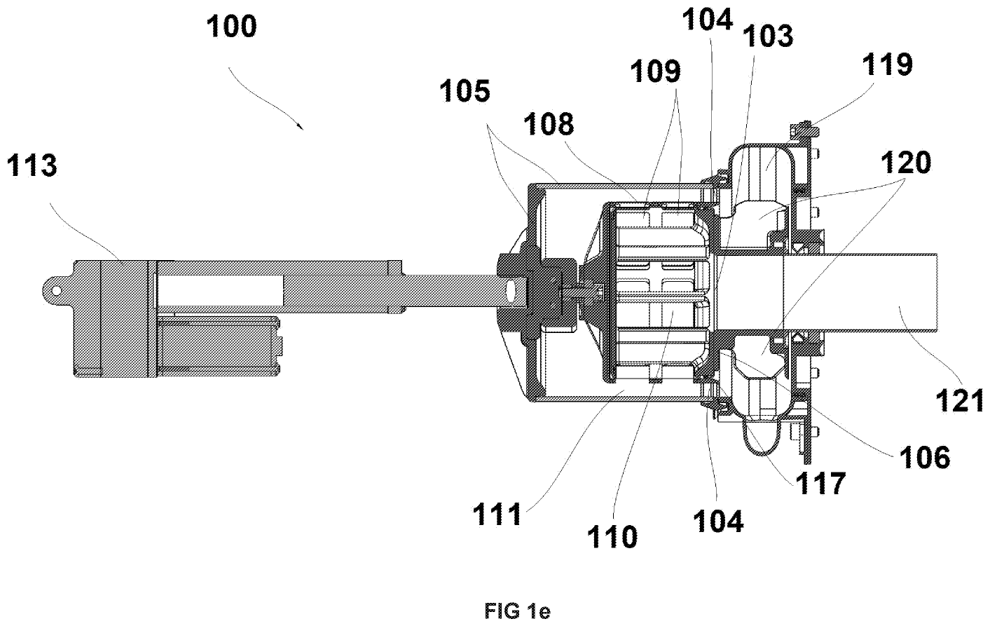

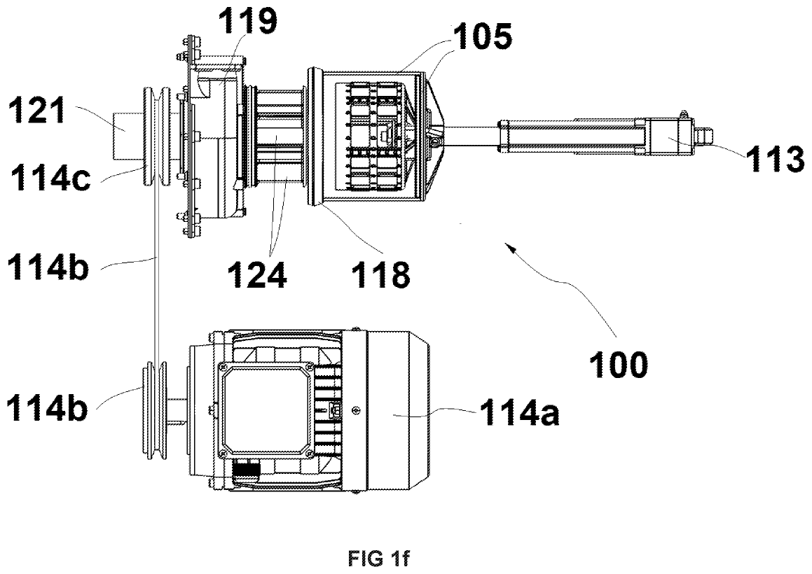

With reference to FIGS. 1a-1f a microparticle filter 100 is shown. The microparticle filter 100 comprises a filter chamber 102. The filter chamber 102 is comprised of a first set of chamber walls 105 and a second set of chamber walls 106. In various embodiments the sets of chamber walls may comprise any number of walls, including one wall or more than one wall. However, in the embodiment of FIGS. 1a-1f the first set of chamber walls 105 comprises an approximately circular end wall and a cylindrical side wall attached thereto, to approximate a cylinder with an open end. The second set of chamber walls 106 comprises a single end wall parallel to and opposing the end wall of the first set of chamber walls 105. The filter chamber 102 also comprises an inlet 103 and an outlet 104 in the second set of chamber walls 106. In the embodiment of FIGS. 1a-e the inlet 103 is shown as a hole in the centre of the single end wall of the second set of chamber walls 106. The outlet 104 is also in the single end wall of the second set of chamber walls 106. The outlet 104 is an annular aperture positioned radially outwards of the inlet 103 and extending around the inlet 103 through 360 degrees. Effluent containing microparticles enters the filter chamber 102 through the inlet 103 and filtered effluent leaves the filter chamber 102 through the outlet 104.

The first set of chamber walls 105 can be moved relative to the second set of chamber walls 106 between two configurations via the actuator 113. FIGS. 1a, 1b and 1e show the first configuration where the filter chamber 102 is sealed and effluent may enter only via the inlet 103 and leave via the outlet 104. No effluent can pass between the first and second set of chamber walls 105, 106. An outer annular seal 118 between the first and second set of chamber walls 105, 106 helps to prevent leakage out of the filter chamber 102, the seal may be in the form of an O-ring fixed to the second set of chamber walls. FIGS. 1c, 1d and 1f show the second configuration wherein the first set of chamber walls 105 have been linearly separated from the second set of chamber walls 106 along axis 1 to present an opening 107 therebetween for the extraction of filter residue therethrough.

The actuator 113 in the embodiment of FIG. 1a-1f is also connected to a filter cage 108 via the first set of chamber walls 105 and it moves with the first set of chamber walls 105 between the first and second configurations parallel with the axis 1. A rotary bearing between the first set of chamber walls 105 and the filter cage 108 permits the filter cage 108 to rotate independently of the first set of chamber walls 105.

The filter cage 108 approximates a cylinder, having a closed end adjacent to the end wall of the first set of chamber walls 105 and an open end adjacent to the second set of chamber walls 106. The filter cage 108 approximates an interior volume 110 which is also approximately cylindrical in shape. Where a filter cage 108 comprises an open end, the interior volume 110 can be bounded by a hypothetical plane covering the opening to the filter cage 108, hence the interior volume 110 in FIGS. 1a-1f is cylindrical like the filter cage 108.

The filter cage 108 comprises a filter medium 109, the filter medium 109 comprises a porous material of a suitable size to filter microparticles from the effluent, e.g. a polyamide mesh with a pore size of 50 μm.

The microparticle filter 100 also comprises a transfer member 112. The transfer member is rotatable around the axis 1 and is driven by a drive unit 114 (shown in FIG. 1f only). The drive means comprises a motor 114a with a first pulley 114b on the rotor of the motor 114a. The first pulley is connected to a second pulley 114c on supply pipe 121 via a belt 114d. In the embodiment of FIGS. 1a-1f the transfer member 112 is connected to supply pipe 121, both of which are mounted on rotary bearings. The supply pipe 121 rotates and functions as a drive shaft for the transfer member 112. The drive unit thus rotates the transfer member 112 via the supply pipe 121. Rotary drive may be transferred from the drive unit (e.g. a motor) via a pulley or a geared connection to the supply pipe 121 from the drive unit, alternatively the drive unit may be connected directly to the supply pipe 121 for example.

The transfer member 112 comprises two circular disks. One disk is the filter residue collector 115 which is adjacent to the end wall of the first set of chamber walls 105. The filter residue collector 115 is circular in shape and has a diameter that approximates the internal diameter of the filter cage 108, thus it has the same cross-sectional shape. The filter residue collector 115 is shaped for intimate contact with the filter medium 109 so that when the filter cage 108 is moved to the second configuration from the first configuration, the filter residue collector 115 scrapes filter residue off the filter medium 109 transferring it to the transfer member 112. The filter residue collector 115 comprises a conformable edge for contacting the filter medium 109, which may comprise a rubber edge around the circumference of the disk.

The other disk is the base 125 of the transfer member. The base 125 is spaced along the axis from the filter residue collector 115 and is positioned adjacent to the second set of chamber walls 106. The base 125 comprises a hole 127 to allow effluent from the inlet 103 to enter the interior volume 110 of the filter cage 108 when the microparticle filter 100 is in the first configuration. The filter residue collector 115 and the base 125 are spaced apart by a set of flow induction blades 124. These blades 124 extend parallel to the axis 1 and are positioned radially outwards of the axis and spaced equally around the circumference of the transfer member 112. Their elongate faces are aligned with the radial direction from the axis 1. The base 125 in combination with the open end of the filter cage 108 forms an inner annual seal 117 when in the first configuration to prevent leakage of unfiltered effluent bypassing the filter medium 109 by leaking from the inner volume 110 to space external 111 to the inner volume.

When the microparticle filter 100 is the first configuration, the transfer member 112 is located in the interior volume 110 of the filter cage 108. In this configuration, rotation of the transfer member 112 by the drive unit causes rotation of the filter cage 108 via rotation of the transfer member 112. An interference fit between the filter residue collector 115 and/or the base 125 or any part of the transfer member 112 with filter cage 108 is able to transfer rotary drive to the filter cage 108.

In the second configuration the transfer member 112 and filter cage 108 are separated along the axis 1 by the actuator 113. In this configuration the opening 107 extends through 360 degrees around the transfer member 112. When the transfer member 112 is rotated filter residue is thrown off the transfer member 112 through the opening 107 via centrifugal force.

The microparticle filter 100 or indeed any embodiment described herein may comprise a collection chamber (not shown). The collection chamber may be positioned radially outwards of the opening 107 and may optionally extend 360 degrees around the opening 107. The collection chamber is a container for collecting residue thrown from the microparticle filter 100.

The microparticle filter 100 of FIGS. 1a-1f comprises an impellor chamber 119. The impellor chamber 119 is fluidly connected to and adjacent to the annular outlet 104 of the filter chamber 102. The impellor chamber 119 receives filtered effluent from the outlet 104. The impellor chamber 119 comprises an impellor 120 in the impellor chamber 119 which comprises multiple impellor blades. The impellor 120 is mounted on the supply pipe 112 and rotates around the axis 1 driven by the drive unit. Rotation of the impellor 120 helps to expel filtered effluent from the impellor chamber 119 via an outflow pipe 122 which is tangentially positioned at the top of the impellor chamber 119. In use, the impellor chamber 119 and impellor 120 draw effluent through the filter chamber 102 and may increase the flow rate through the microparticle filter 100. The impellor chamber 119 also comprises a secondary outflow pipe 123 at the bottom dead centre of the impellor chamber 119 to allow residual liquid to drain from the impellor chamber 119. The lowermost portion of the impellor chamber 119 is below the filter chamber 102 so any residual liquid in the filter chamber 102 will drain into the impellor chamber 119 and out of the secondary outflow pipe 123.

In use, the microparticle filter 100 is connected to a source of effluent such as a textile treatment apparatus (e.g. a domestic or commercial washing machine, amongst others). The source of effluent is connected to the microparticle filter 100 so that effluent is provided to the inlet 103 of the microparticle filter 100. Before effluent is supplied to the inlet 103 the microparticle filter 100 is placed in the first configuration by operating the actuator 113. This brings the first set of chamber walls 105 into contact with the second set of chamber walls 106 to form a sealed unit. The outer annular seal 118 prevents fluid leakage between the two sets of chamber walls in the first configuration. Effluent provided to the inlet 103 passes into the filter chamber 102 via the hole in the base 125 of the transfer member 112. The drive unit may be operated to rotate the transfer member 112 and because of contact between the transfer member 112 and the filter cage 108, rotary drive is transferred to the filter cage 108 to cause rotation thereof. Rotation of the transfer member 112 causes the flow induction blades 124 to induce rotary flow of the effluent within the filter chamber 102. This drives effluent through the filter medium 109 and out of the filter cage 108 to the outlet 104. The effluent is pulled into the impellor chamber 119 by the rotation of the impellor 120 which is also rotated by the drive unit and effluent is pumped out of the impellor chamber 119 via the outflow pipe 122. After filtration is complete the supply of effluent is stopped. This may be via a valve upstream of the inlet 103 or within the source of effluent itself. Filtered effluent is allowed to drain from the microparticle filter 100 and out of the impellor chamber 119. Any residual liquid in the filter chamber 102 or impellor chamber 119 may be drained from the secondary outflow pipe 123 which may optionally comprise a valve. Once filtered effluent has drained from the impellor chamber 119 and the filter chamber 102 the filter cage 108 may optionally be rotated by the drive unit to dewater the filtered residue accumulated on the surface of the filter medium 109. Rotation may throw water from the residue by centrifugal force to dewater the residue.

The microparticle filter 100 may be placed in the second configuration by operating the actuator 113 to separate the first and second sets of chamber walls 105, 106 and to move the filter cage 108 from around the transfer member 112. This presents the opening 107 between the sets of chamber walls 105, 106, which radially surrounds the transfer member 112. As the filter cage 108 is pulled by the actuator 113 away from the transfer member 112 the residue accumulated on the surface of the filter medium 109 is scraped away by the filter residue collector 115 where it accumulates on the transfer member 112. The transfer member 112 is then rotated by the drive unit at a sufficient speed to throw the transferred residue from the transfer member 112 through the opening 107. The microparticle filter 100 may then be returned to the first configuration to resume filtration.

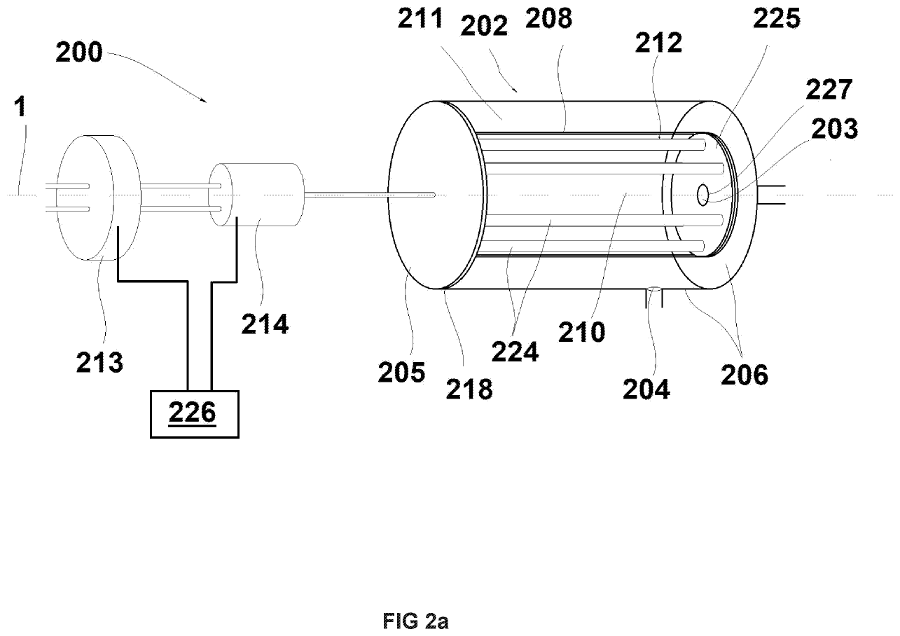

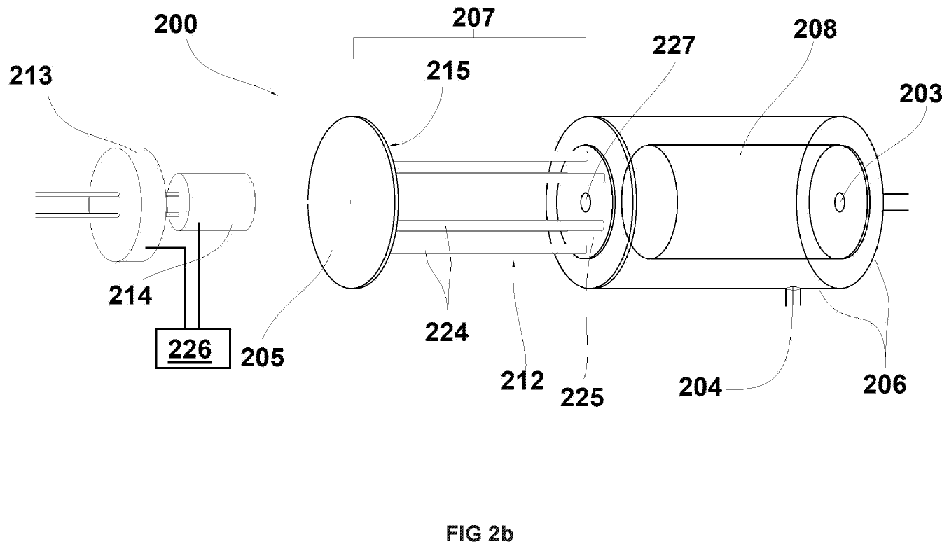

With reference to FIGS. 2a and 2b an alternative microparticle filter 200 is shown. The microparticle filter 200 comprises a filter chamber 202. The filter chamber 202 is comprised of a first set of chamber walls 205 and a second set of chamber walls 206. In the embodiment of FIGS. 2a and 2b the first set of chamber walls 205 comprises a single approximately circular end wall. The second set of chamber walls 206 comprises a single end wall and a cylindrical side wall attached thereto which approximates an open-ended cylinder. The filter chamber 202 also comprises an inlet 203 and an outlet 204. In the embodiment of FIGS. 2a and 2b the inlet 203 is a hole in the end wall of the second set of chamber walls 206. The outlet 204 is a hole in the cylindrical sidewall of the second set of chamber walls 206. Microparticle containing effluent enters the filter chamber 202 through the inlet 203 and filtered effluent leaves the filter chamber 202 through the outlet 204.

The first set of chamber walls 205 can be moved relative to the second set of chamber walls 206, between two configurations via actuator 213. FIG. 2a shows the first configuration wherein the filter chamber 202 is a sealed unit wherein effluent may enter only via the inlet 203 and leave via the outlet 204. An outer annular seal 218 between the first and the second set of chamber 206 walls may further reduce or eliminate leakage out of the filter chamber 202. FIG. 2b shows the second configuration wherein the first set of chamber walls 205 have been separated from the second set of chamber walls 206 to present an opening 207 therebetween for the extraction of filter residue therethrough.

In the embodiment of FIGS. 2a and 2b the filter cage 208 is fluidly connected to inlet 203 and is mounted on a rotary bearing to the second set of chamber walls 206. The filter cage 208 approximates a cylinder, having a closed end save for a passage from the inlet 203 adjacent to the end wall of the second set of chamber walls 206 and an open end adjacent to the first set of chamber walls 205. The filter cage 208 approximates an interior volume 210 which is also approximately cylindrical in shape. The sides of the filter cage 208 comprise a porous filter medium for filtering microparticles from the effluent.

The actuator 213 in the embodiment of FIGS. 2a and 2b is connected to the first set of chamber walls 205 and to the transfer member 212. The actuator 213 linearly moves the transfer member 212 and the first set of chamber walls 205 between the first and second configurations parallel with the axis 1. A rotary bearing (not shown) between the second set of chamber walls 206 and the filter cage 208 permits the filter cage 208 to rotate independently of the second set of chamber walls 206.

The transfer member 212 is rotatable around the axis 1 and is driven by a drive unit 214. The transfer member 212 comprises two circular disks. One disk is the filter residue collector 215 (obscured by the first set of chamber walls 205 in FIG. 2a) which is adjacent to the end wall of the second set of chamber walls 206. The filter residue collector 215 is circular in shape and has a diameter that approximates the internal diameter of the filter cage 208, thus it has the same cross-sectional shape. The filter residue collector 215 additionally has a central hole 227 aligned with the inlet 203 to allow effluent from the inlet 203 to enter the centre of the transfer member 212. The other disk is the transfer member base 225, which is spaced along the axis from the filter residue collector 215 and is positioned adjacent to the first set of chamber walls 205. The filter residue collector 215 and the base 225 are spaced apart by a set of flow induction blades 224. These blades extend parallel to the axis and are positioned radially outwards of the axis, spaced equally around the perimeter of the transfer member 212. Their elongate faces are aligned with the radial direction from the axis. The base 225 in combination with the open end of the filter cage 208 forms an inner annual seal. When the microparticle filter 200 is in the first configuration, the inner annular seal prevents leakage of unfiltered effluent bypassing the filter medium by leaking from the inner volume 210 to space in the filter chamber 202 that is external to the inner volume 211.

When the microparticle filter 200 is the first configuration, the transfer member 212 is located in the interior volume 210 of the filter cage 208. In this configuration, rotation of the transfer member 212 by the drive unit 214 causes rotation of the filter cage 208 via rotation of the transfer member 212. An interference fit between the filter residue collector 215 and/or the base 225 or any part of the transfer member 212 with filter cage 208 is able to transfer rotary drive to the filter cage 208.

In the second configuration the transfer member 212 and filter cage 208 have

been separated along the axis by the actuator 213. In this configuration the opening 207 extends through 360 degrees around the transfer member 212. When the transfer member 212 is rotated transferred filter residue is thrown off the transfer member 212 through the opening 207 via centrifugal force.

Also shown in FIG. 2a and FIG. 2b is a controller 226 for operating the

actuator 213 and drive unit 214. The controller 226 may contain or have access to control logic for generating a control signal to the actuator 213 or drive unit 214 dependent on the input received. The controller 226 may control the actuator 213 to move the microparticle filter 200 between the first and second configurations. The controller 226 may also control the drive unit 214 to rotate during filtration, during dewatering or when throwing residue from the transfer member 226. The control unit may receive inputs from a textile treatment apparatus or from pressure or other sensors in the microparticle filter 200 or in conduits connecting to the inlet 203 and/or outlet 204. The controller 226 is shown for FIGS. 2a and 2b only but it is equally applicable to the other microparticle filters embodied in the figures, claims or in the

### SUMMARY OF THE INVENTION

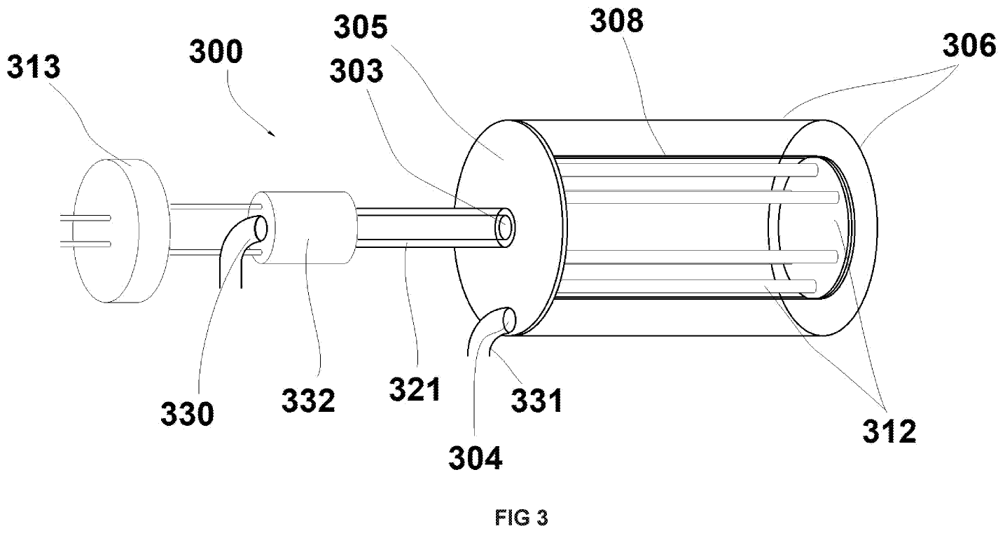

With reference to FIG. 3 an alternative microparticle filter 300 is shown. The microparticle filter 300 comprises a first and a second set of chamber walls 305, 306, a transfer member 312, an actuator 313, and a filter cage 308 in the same arrangement as the embodiment of FIGS. 2a and 2b. However, the inlet 303 and outlet 304 are in the end wall that comprises the first set of chamber walls 305. The inlet 303 and outlet 304 are connected to a source of effluent and a drain respectively via flexible hoses 330 and 331 to accommodate movement of the first set of chamber walls 305. The hose 330 for the inlet 303 extends through the motor 332 and an interior of the drive shaft 321 to provide effluent to the centre of the transfer member 312. The drive shaft is connected between the motor 332 and the transfer member 312 to provide rotation of the transfer member 312. However, in other embodiments effluent may be provided to an inlet without passing through the motor or drive shaft.

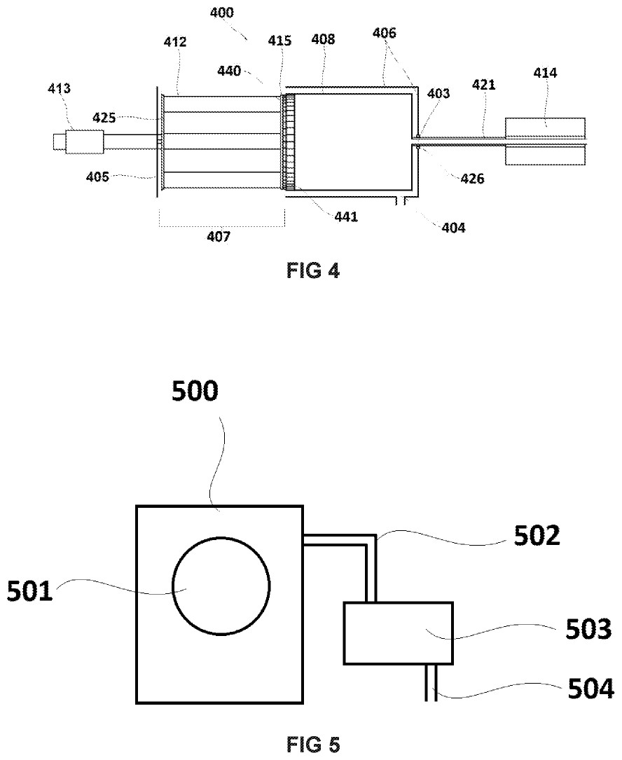

Referring to FIG. 4, an alternative microparticle filter 400 is shown. The

microparticle filter 400 comprises a first and a second set of chamber walls 405, 406, an inlet 403 and an outlet 404. The actuator 413 is arranged to move the transfer member 412 and the first set of chamber walls 405 between the first and second configurations. FIG. 4 shows the microparticle filter 400 in the second configuration only. The microparticle filter 400 also comprises a filter cage 408 rotatably mounted to the second set of chamber walls 406 via rotary bearing 426. The inlet 403 is positioned at the end wall comprised as part of the second set of chamber walls 406. The filter cage 408 is connected to a drive shaft 421 which has a hollow bore that supplies effluent to the inlet 403 and into the filter cage 408, thus the drive shaft 421 also functions as a supply pipe. The drive shaft 421 is rotated by the drive unit 414 which is a motor, which also has a hollow bore in the rotor for the supply of effluent into the drive shaft 421. The filter cage 408 comprises a set of splines 441 which extend around the inside of the open end of the filter cage 408. The transfer member 412 also comprises a set of cooperating splines 440 which engage with the splines 441 of the filter cage 408 when the microparticle filter 400 is in the second configuration. Rotation of the filter cage 408 via the drive unit 414 and drive shaft 421 causes rotation of the transfer member 412 with drive transferred through the splines 440 and 441, to throw residue through opening 407.

With reference to FIG. 5 a textile treatment apparatus 500 is shown. The textile treatment apparatus 500 comprises a rotary drum 501 where textiles are treated and a microparticle filter 503 located externally to the textile treatment apparatus 500. An effluent drain 502 conveys effluent from the treatment of textiles to a microparticle filter 503. A drain connection 504 conveys filtered effluent from the microparticle filter 503 to the drain/sewer system.

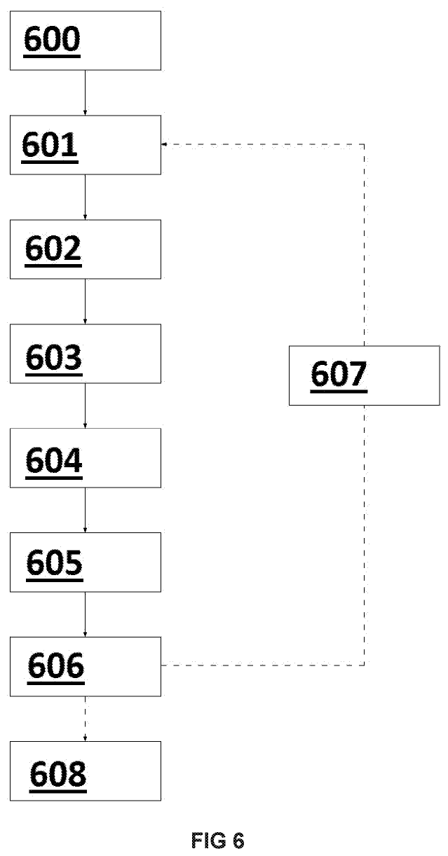

With reference to FIG. 6 a flow diagram illustrates a method according to the third aspect of the invention. In step 600 a microparticle filter is provided. This may be any microparticle filter in accordance with the first aspect of the present disclosure. In step 601 the microparticle filter is placed into the first configuration by operating the actuator accordingly. In step 602 effluent from a textile treatment apparatus is supplied into the microparticle filter via the inlet. In step 603 the effluent is filtered of microparticles as it passes through the filter medium. Optionally the filter cage is rotated via the drive unit during filtration. After the effluent has been filtered the supply of effluent from the textile treatment apparatus may be stopped in step 604. Residual effluent in the microparticle filter may be allowed to drain. Optionally, the filter cage may be rotated to throw any residual liquid off to dewater the filter residue. In step 605 the actuator may be operated to place the microparticle filter into the second configuration. In doing so, residue accumulated on the filter medium may be transferred to the transfer member. In step 606, the drive unit is operated to throw transferred residue from the transfer member out of the microparticle filter. Optionally this may be collected in a collection container. The method further comprises the optional step 607, of repeating steps 601 to 606. In optional step 608 where a collection chamber is used, the collection chamber may be emptied of collected filter residue.

As used herein, the term “comprising” encompasses “including” as well as “consisting” and “consisting essentially of” e.g. a composition “comprising” X may consist exclusively of X or may include something additional e.g. X +Y. As used herein, the words “a” or “an” are not limited to the singular but are understood to include a plurality, unless the context requires otherwise. Thus, words such as “an item” also mean “one or more items”. It will be appreciated that any item, feature, parameter or component described herein may, where appropriate, relate to any of the aspects of the present invention.

1. A microparticle filter suitable for filtering microparticles from effluent from a textile treatment apparatus, the microparticle filter comprising:
i) a filter chamber, the filter chamber comprising:
an inlet for supplying effluent into the filter chamber and an outlet for filtered effluent to leave the filter chamber;
a first set of chamber walls and a second set of chamber walls, wherein the first set of chamber walls and the second set of chamber walls in a first configuration are sealed together so that effluent cannot pass between the first set of chamber walls and the second set of chamber walls, and wherein the first set of chamber walls and the second set of chamber walls in a second configuration provide an opening;
ii) a filter cage contained within the filter chamber, wherein the filter cage comprises one or more than one filter medium, the filter medium to filter microparticles from the effluent, and wherein the filter cage is rotatable around an axis, and wherein the filter cage defines an interior volume, and wherein the inlet is arranged to provide effluent to the interior volume of the filter cage and the outlet is arranged to receive filtered effluent from the filter cage;
iii) a transfer member rotatable around the axis;
iv) an actuator connected to the first set of chamber walls, and one of the filter cage or the transfer member and operable to move between the first configuration and the second configuration;
v) a drive unit arranged to rotate the transfer member in at least the second configuration;
wherein in the first configuration, the transfer member is located in the interior volume of the filter cage; and
wherein in a second configuration, the transfer member is removed from the interior volume of the filter cage along the axis and the transfer member is rotatable to throw transferred filter residue off the transfer member through the opening, and wherein the transfer member comprises a filter residue collector to remove filter residue from the filter medium when the filter is changed from the first configuration from the second configuration.

2. A microparticle filter according to claim 1, wherein the actuator is connected to the first set of chamber walls and to the filter cage.

3. A microparticle filter according to claim 1, wherein rotation of the transfer member by the drive unit causes rotation of the filter cage via rotation of the transfer member when the filter is in the first configuration only.

4. A microparticle filter according to claim 1, wherein the actuator linearly moves the filter cage and the first set of chamber walls together between configurations when actuated.

5. A microparticle filter according to claim 1, wherein the first set of chamber walls and the filter cage are connected via a rotary bearing, permitting independent rotation therebetween.

6. A microparticle filter according to claim 1, wherein the inlet and the outlet are both in the first set of chamber walls or both in the second set of chamber walls of the filter chamber, or optionally the inlet and the outlet are both in a same individual chamber wall of a set of chamber walls.

7. A microparticle filter according to claim 6, wherein the outlet is annularly shaped and radially outwards of the inlet.

8. A microparticle filter according to claim 1, comprising an inner annular seal for sealing the filter cage to the transfer member when the filter is in the first configuration.

9. A microparticle filter according to claim 1, comprising an outer annular seal for sealing the first set of chamber walls to the second set of chamber walls when the filter is in the first configuration.

10. A microparticle filter according to claim 1, comprising an impellor chamber connected to and adjacent to the outlet of the filter chamber to receive filtered effluent from the outlet of the filter chamber, wherein the impellor chamber comprises an impellor in the impellor chamber which is rotatable around the axis by a drive unit to expel filtered effluent from the impellor chamber.

11. A microparticle filter according to claim 10, comprising a supply pipe to provide effluent to the inlet, the supply pipe passing through the impellor chamber parallel with the axis; and/or wherein the impellor chamber comprises an outflow pipe, and optionally a secondary outflow pipe below the impellor chamber individual chamber for draining effluent from the impellor chamber.

12. (canceled)

13. (canceled)

14. A microparticle filter according to claim 1, wherein the filter residue collector comprises a cross sectional shape geometrically similar to the cross-section of the interior volume, taken perpendicular to the axis.

15. A microparticle filter according to claim 14, wherein the filter residue collector comprises a conformable member for contacting the filter medium.

16. A microparticle filter according to claim 1, wherein the transfer member comprises one or more than one flow induction blades which extend approximately parallel to the axis and are positioned radially outwards thereof, optionally wherein more than one flow induction blades are equally spaced around the perimeter of the transfer member.

17. A microparticle filter according to claim 1, wherein the microparticle filter further comprises a controller, the controller able to access logic to operate the actuator and drive unit to place the filter cage in the first configuration and second configuration and to rotate the transfer member in the second configuration.

18. A textile treatment apparatus comprising the microparticle filter according to claim 1.

19. (canceled)

20. Use of the microparticle filter or textile treatment apparatus according to claim 1, for filtering microparticles from an effluent stream comprising effluent from treated textiles.

21. (canceled)

22. A method of filtering microparticles from effluent from a textile treatment apparatus comprising:
i. providing a microparticle filter according to claim 1;
ii. operating the actuator to place the microparticle filter in the first configuration;
iii. supplying effluent from a textile treatment apparatus to the inlet of the microparticle filter;
iv. filtering the effluent through the filter medium and passing the filtered effluent to the
v. stopping the supply of effluent;
outlet;
vi. operating the actuator to place the microparticle filter in the second configuration;
vii. operating the drive unit to rotate the transfer member to throw filter residue from the transfer member out of the opening.

23. A method according to claim 22, further comprising the subsequent steps of:
viii. repeating steps ii. to vii. one or more than one times.

24. A method according to claim 22, wherein the filter residue is dewatered by rotating the filter cage between steps v and vi.
